(19) United States
(12) Patent Application Publication
(10) Pub. No.: US 2013/0107113 A1
(43) Pub. Date: May 2, 2013

(54) OPTICAL COMPONENT, METHOD OF MANUFACTURING OPTICAL COMPONENT, AND CAMERA MODULE

(71) Applicant: Sony Corporation, Tokyo (JP)

(72) Inventor: Minoru Tazoe, Tokyo (JP)

(73) Assignee: SONY CORPORATION, Tokyo (JP)

(21) Appl. No.: 13/659,468

(22) Filed: Oct. 24, 2012

(30) Foreign Application Priority Data
Oct. 31, 2011 (JP) 2011-238717

(51) Int. Cl. G02B 7/02; H04N 5/225; B32B 37/12

(52) U.S. Cl. 348/374; 359/811; 156/109; 348/E05.028

(57) ABSTRACT

An optical component includes a first glass substrate, a second glass substrate that opposes the first glass substrate, a lens that is formed on at least one of the first glass substrate and the second glass substrate, and a connection portion that is interposed between the two glass substrates in such a manner that a hollow portion is formed between the first glass substrate and the second glass substrate, and is configured to use a material which includes a porous material in at least one portion.

### CROSS REFERENCES TO RELATED APPLICATIONS

The present application claims priority to Japanese Priority Patent Application JP 2011-238717 filed in the Japan Patent Office on Oct. 31, 2011, the entire content of which is hereby incorporated by reference.

### BACKGROUND

The present disclosure relates to an optical component where a lens is formed on at least one of two glass substrates that oppose each other, a method of manufacturing the optical component and a camera module using the optical component.

Portable electronic apparatuses, such as portable phones and smartphones, having a camera function have become wide spread. In such electronic apparatuses, it is necessary to decrease the size and thickness of an optical system of a camera according to demand for decrease in size and thickness of the apparatuses. However, in a method of disposing plural lenses which form an optical system by holding the plural lenses in a lens barrel, it is difficult to decrease the size and thickness because the volume occupied by the lens barrel becomes larger.

Therefore, in such electronic apparatuses, from the past, a method of disposing the plural lenses which form the optical system of a camera using a semiconductor manufacturing technology as follows has been adopted.

An optical component having a bonded structure is manufactured, where a lens is formed on both sides or one side of two glass substrates, the glass substrates oppose each other, and a hollow portion which is an enclosed region is included therebetween.

Either one or plural optical components are used by being stacked so that the plural lenses are disposed.

A method such as flow or reflow may be used in the process of soldering a camera module including such an optical component and imaging device on a printed wiring substrate in the electronic apparatuses. However, in a case where the soldering is performed by the reflow, the air inside the hollow portion of the optical component expands due to the heat added to the printed wiring substrate. If a crack occurs in adhesive layer of the optical component due to the expansion of the air, the dust-resistance would be decreased. Therefore, in such an optical component in the past, it was necessary to have a heavy structure in order to withstand the expansion of air.

Further, in the field of semiconductor apparatuses, a technology to solve problems caused by the expansion of the air has been proposed as follows (for example, refer to Paragraph [0006] and Abstract in Japanese Unexamined Patent Application Publication No. 2005-322809).

An adhesive portion bonds a main surface and a translucent cover portion of a solid-state imaging device and forms a hollow portion therebetween, and the adhesive portion is formed of a first opening end portion on the hollow portion, a second opening end portion on external side, and a capture portion which supplements water.

A ventiduct is formed by the first opening end portion, the capture portion and the second opening end portion.

The shape of the ventiduct is formed such that the verdict is not connected to the first opening end portion and the second opening end portion in a straight line, but is connected to an inside of the adhesive portion through the capture portion which has a larger than that of the first opening end portion and the second opening end portion.

### SUMMARY

However, making an optical component with a heavy structure in order to withstand the expansion of air would cause an enlargement of the optical component, which may be against the demand for decreases in size and thickness. In the technology described in Paragraph [0006] and Abstract in Japanese Unexamined Patent Application Publication No. 2005-322809, as the volume occupied by the ventiduct increases, the optical component also enlarges, such that the structure thereof becomes complicated.

Accordingly, in the present disclosure, it is desirable to provide a method of manufacturing an optical component, and a camera module to solve problems caused by the expansion of air when soldering is performed by the reflow as above mentioned without causing the structure to be enlarged or complicated.

According to an embodiment of the present disclosure, there is provided an optical component including a lens that is formed on at least one of two glass substrates, wherein the two glass substrates are connected to each other through a material which includes a porous material in at least one portion in such a manner that the two glass substrates oppose each other and a hollow portion is formed between the two substrates.

According to another embodiment of the present disclosure, there is provided a method of manufacturing the optical component including applying a silicone resin to a peripheral region of a lens for each glass substrate where a plurality of lenses are arranged and formed, and bonding two glass substrates of the glass substrate and a different glass substrate through the silicone resin in such a manner that the two glass substrates oppose each other and have a hollow portion therebetween for each lens region, and dividing the two bonded glass substrates into respective components using the silicone applied to the peripheral region of each lens as a dividing line.

Further, according to still another embodiment of the present disclosure, there is provided a camera module including an imaging device and an optical system causing an image of subject to be incident on the imaging device, wherein the optical system uses an optical component, where a lens is formed on at least one of two glass substrates, and the two glass substrates are connected to each other through a material which includes a porous material in at least one portion in such a manner that the two glass substrates oppose each other and a hollow portion is formed between the two substrates.

According to the optical component of the present disclosure, when a soldering is performed by reflow, air inside the hollow portion which is expanded due to heat is discharged to the outside through a portion of porous material in the material (connection portion) separating the hollow portion from the outside.

In this way, it is possible to manufacture the optical component capable of preventing cracking in the adhesive portion caused by the expansion of air in the hollow portion from occurring without causing the structure to be enlarged or complicated.

According to the method of manufacturing an optical component of the present disclosure, it may be possible to manufacture the optical component capable of preventing cracking in the adhesive layer caused by the expansion of air in the hollow portion from occurring without causing the structure to be enlarged or complicated.

According to the camera module of the present disclosure, as the optical system causing an image of subject to be incident on the imaging device, the optical component according to the present disclosure as mentioned above is used. In this way, it may be possible to manufacture the optical component which is capable of preventing cracking in the adhesive portion caused by the expansion of air in the hollow portion from occurring when soldering is performed by reflow without causing the structure to be enlarged or complicated.

Additional features and advantages are described herein, and will be apparent from the following Detailed Description and the figures.

### BRIEF DESCRIPTION OF THE FIGURES

FIGS. 1A and 1B are diagrams illustrating a structure of an optical component according to a first embodiment of the present disclosure.

FIGS. 2A to 2E are diagrams illustrating a method of manufacturing an optical component according to the first embodiment of the present disclosure.

FIG. 3 is a diagram illustrating a structure of camera module according to a second embodiment of the present disclosure.

FIGS. 4A and 4B are diagrams illustrating a structure of an optical component according to a third embodiment of the present disclosure.

FIGS. 5A to 5D are diagrams illustrating a structure of configuration element of an optical component according to the third embodiment of the present disclosure.

FIGS. 6A to 6E are diagrams illustrating a method of manufacturing an optical component according to the third embodiment of the present disclosure.

### DETAILED DESCRIPTION

While referring to the accompanying drawing, a description will be given with respect to an example of the embodiment. Further, in the specification and drawings of the present disclosure, constituent elements having substantially the same function or configuration are given the same reference numerals, and repeated description is omitted.

The description will be provided in the following order.

1. First embodiment (optical component: example using a silicone resin)
2. Second embodiment (camera module: example using the optical component)
3. Third embodiment (optical component: example using a porous film)
4. Modified example

### 1. First Embodiment

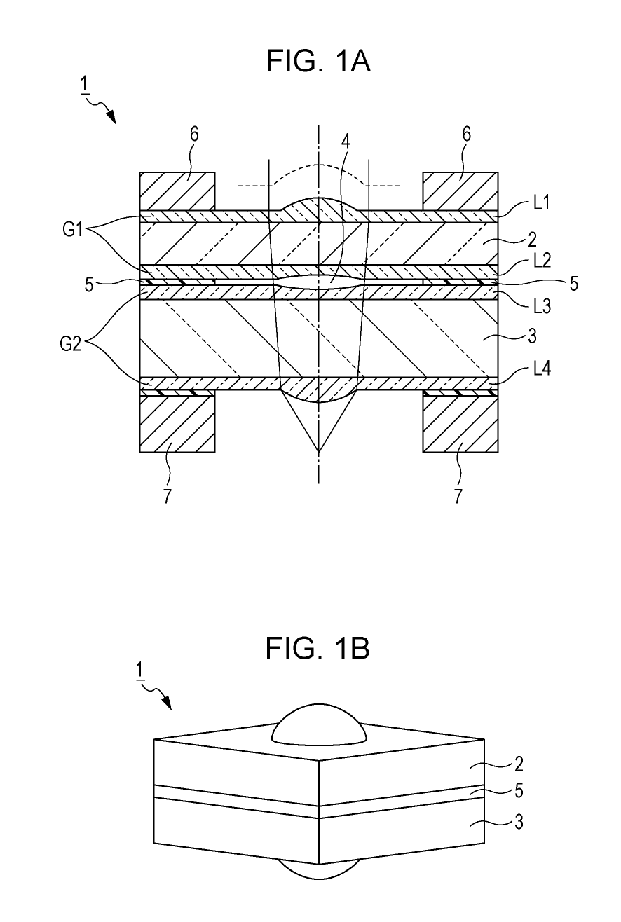

FIGS. 1A and 1B illustrate a structure of an optical component according to the first embodiment of the present disclosure; FIG. 1A is a cross-sectional view, and FIG. 1B is a perspective view illustrating the external appearance schematically. The optical component 1 is used in an optical system of camera module mounted in electronic apparatuses such as a portable phone, and a smartphone.

As illustrated in FIG. 1A, in the optical component 1, a first lens group G1 and a second lens group G2 which are made of a transparent resin are respectively formed on two glass substrates 2 and 3. The first lens group G1 is configured to be a lens L1 that is formed on a substrate surface (the substrate surface of an upper side in the drawing) of subject side of the glass substrate 2 and a lens L2 that is formed on a substrate surface (the substrate surface on the lower side in the drawing) of the image side of the glass substrate 2. The second lens group G2 is configured to be a lens L3 that is formed on a substrate surface of subject side of the glass substrate 3 and a lens L4 that is formed on a substrate surface of image side of the glass substrate 3.

The glass substrates 2 and 3 thereof are opposed to each other and have a hollow portion 4 which is an enclosed region between the glass substrate 2 and the glass substrate 3, and are connected through the silicone RTV (Room Temperature Vulcanizing) resin 5. The silicone RTV resin 5 is an example of silicone which is used as a connection portion in the present disclosure. As the silicone RTV resin 5, for example, “KE-348T”, manufactured by Shin-Etsu Silicone is used. In addition, in the vicinity of the outer periphery portion of the substrate surface of subject side of the glass substrate 2, a spacer 6 is bonded to protect the lens L1, and in the vicinity of the outer periphery portion of the substrate surface of image side of the glass substrate 3, a spacer 7 is bonded to protect the lens L4. Further, in FIG. 1B, along with the spacers 6 and 7 not being illustrated, the first lens group G1 and the second lens group G2 are not illustrated, except for the shape of the central portions of lenses L1 and L4.

Silicone is a porous material (diffusion coefficient is large) and in which oxygen is easily dissolved (solubility coefficient is large), and is derived from a molecular structure of silicone in which an oxygen atom and a methyl group are bonded to a silicon atom. Accordingly, since the silicone RTV resin 5 which is an example of the silicone with a high oxygen permeability coefficient (=diffusion coefficient×diffusion coefficient) indicating the ease of oxygen passing through the substance, silicone RTV resin 5 has high breathability. Further, the silicone RTV resin 5 has a high water repellency, and water does not therethrough.

Since the silicone RTV resin 5 has such characteristics, in the optical component 1, air and water vapor in the hollow portion 4 (molecular diameter of approximately 0.0004 μm) is discharged to the outside through the silicone RTV resin 5. However, a liquid such as water outside the optical component 1 (molecular diameter of approximately 100 to 3000 μm) does not infiltrate into the hollow portion 4 because the liquid does not pass through the silicone RTV resin 5.

According to the optical component 1 with such a structure, when soldering is performed by reflow, the air in the hollow portion 4 which is expanded due to the heat is discharged to the outside through the silicone RTV resin 5. In this way, it is possible to prevent cracking (the silicone RTV resin 5 or, the boundary portion between the glass substrates 2 and 3 and the silicone RTV resin 5) due to expansion of the air in the hollow portion 4 from occurring in an adhesive layer without causing the structure to be enlarged or complicated.

Furthermore, also in a case where water for cutting or cleaning is used in the manufacturing process of the optical component 1, it is possible to prevent the water from infiltrating into the hollow portion 4.

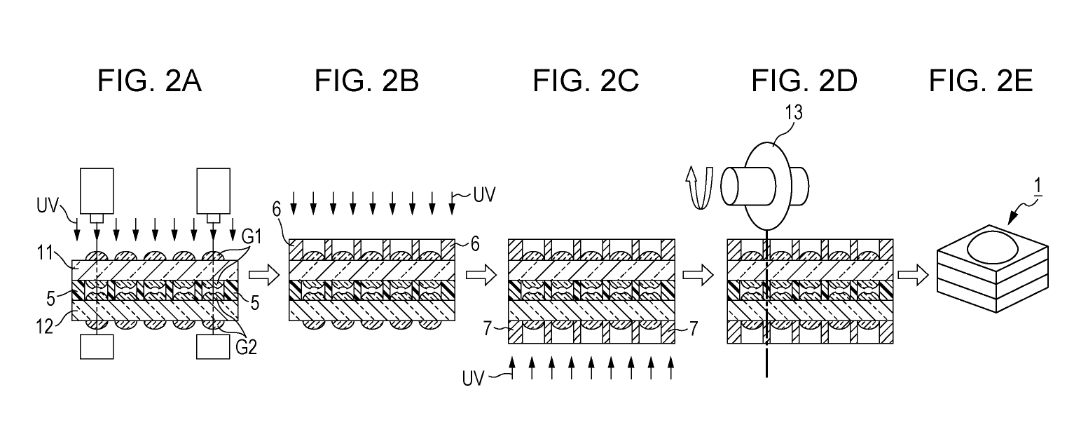

FIGS. 2A to 2E illustrate a method of manufacturing the optical component 1 which is illustrated in FIGS. 1A and 1B, and the same reference numerals are applied to portions common to FIGS. 1A and 1B.

As illustrated in FIG. 2A, the silicone RTV resin 5 is applied with a predetermined thickness to a peripheral region of each second lens group G2 (lens L3 in FIG. 1A) of a subject side of glass substrate 12 on which a plurality of the second lens groups G2 are arranged and formed. Further, an ultraviolet curable resin (not illustrated) is applied to the region out of a substrate surface of the subject side of the glass substrate 12 where the second lens group G2 is not arranged (for example, a region of substrate surface edge).

Further, a glass substrate 11 on which a plurality of the first lens groups G1 are arranged and formed is opposed to the glass substrate 12, and optical axes of the first lens group G1 and the second lens group G2 are aligned to match each other. In addition, the glass substrate 11 is placed on the silicone RTV resin 5 and the ultraviolet curable resin on the glass substrate 12 which is described above.

Further, for the convenience of description, in FIGS. 2A to 2D, only the silicone RTV resin 5 which is disposed in the vicinity of outer periphery portion of the glass substrates 11 and 12 is illustrated as being thick, while the rest of silicone RTV resin 5 which is disposed outside thereof is illustrated as being thin.

Subsequently, ultraviolet rays UV are irradiated uniformly and the ultraviolet curable resin is cured, thus the glass substrate 11 and the glass substrate 12 are temporarily fixed to each other. In addition, the silicone RTV resin 5 is cured at room temperature (normal temperature). In this way, the glass substrates 11 and 12 include the hollow portion 4 which is an enclosed region for every region of each of the first lens groups G1 and second lens groups G2 between the glass substrates 11 and 12 (corresponds to the glass substrates 2 and 3 in FIGS. 1A and 1B), thus the glass substrates 11 and 12 are bonded to each other through the silicone RTV resin 5. Further, since it takes a certain time for the silicone RTV resin 5 to be cured, a temporary fixing is performed using an ultraviolet curable resin such that it is possible to prevent the optical axes of the first lens group G1 and the second lens group G2 from deviating in the meantime.

Subsequently, as illustrated in FIG. 2B, the ultraviolet curable resin (not illustrated) is applied to the peripheral region of each of the first lens groups G1, the spacer 6 is placed thereon, and then the ultraviolet rays UV are irradiated uniformly, such that the spacer 6 is bonded to the substrate surface of the subject side of the glass substrate 11. In the same manner, as illustrated in FIG. 2C, the spacer 7 is bonded to a peripheral region of each of the second lens groups G2 on the substrate surface of the image side of the glass substrate 12.

Subsequently, the glass substrates 11 and 12 which are bonded in this way, as illustrated in FIG. 2D, are divided into respective components by dividing the silicone RTV resin 5 of the peripheral region of each of the first lens groups G1 and the second lens groups G2 using a dicer 13 as a dividing line. In this way, the optical component 1 (the same structure as illustrated in FIGS. 1A and 1B) of which the appearance is schematically shown in FIG. 2E is manufactured in plural numbers at the same time. Further, in the process of dividing using the dicer 13 as illustrated in FIG. 2D, cutting water is applied to the glass substrates 11 and 12, however, since a liquid such as water described above does not pass through the silicone RTV resin 5, it may be possible to prevent the water from infiltrating into the hollow portion 4. In the present embodiment, the shape of optical component 1 seen from upper side or lower side after being divided into respective components is a rectangle, however, it may also be circular.

### 2. Second Embodiment

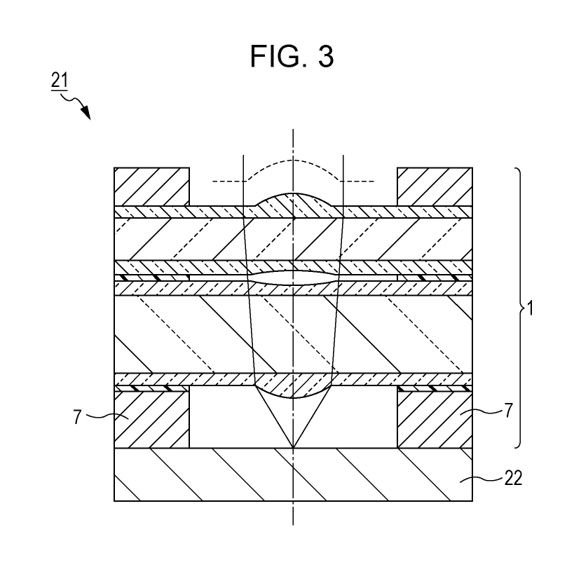

FIG. 3 illustrates a structure of a camera module according to a second embodiment. A camera module 21 is a camera module in which an optical component 1 according to the first embodiment of the present disclosure is used in the optical system, the camera module 21 is mounted, for example, in an electronic apparatus such as a portable phone or a smartphone. An imaging device (for example a CMOS or CCD) 22 is bonded to the spacer 7 of the optical component 1, and a subject image is incident on the imaging device 22 from the first lens group G1 and the second lens group G2 of the optical component 1.

According to the camera module 21, when soldering by reflow is performed on a printed wiring substrate of the electronic apparatuses, air in the hollow portion 4 of the optical component 1 which expands due to the heat is discharged to the outside through the silicone RTV resin 5. In this way, it may be possible to prevent cracking in the adhesive layer of the optical component 1 from occurring due to the expansion of the air in the hollow portion 4 of the optical component 1 without causing the structure to be enlarged or complicated in.

### 3. Third Embodiment

A third embodiment is an example using a porous material which is formed in the shape of film on a part of connection portion of the optical component according to the first embodiment.

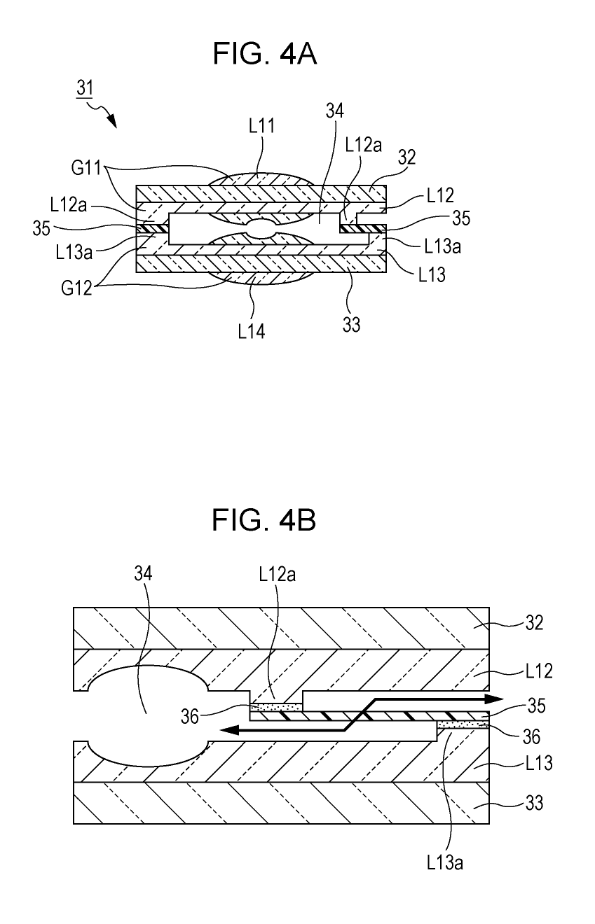

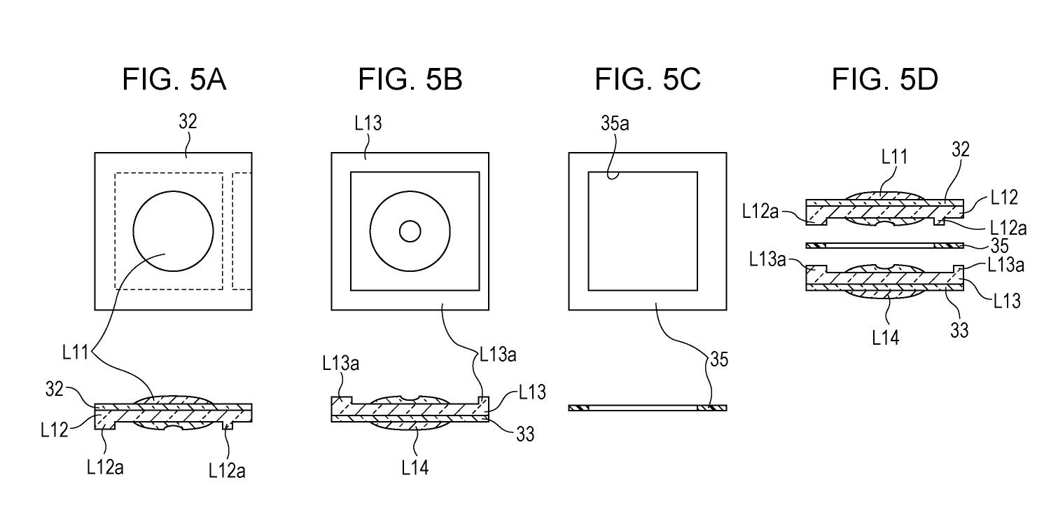

FIGS. 4A and 4B illustrate the structure of an optical component according to the third embodiment of the present disclosure, where FIG. 4A is an overall cross-sectional view and FIG. 4B is a cross-sectional view of an enlarged portion of the right side in FIG. 4A. Further, FIGS. 5A to 5D illustrate the structure of the constituent elements of the optical component, the upper side and the lower side of FIGS. 5A to 5C are respectively a plan view and a cross-sectional view of each constituent element. FIG. 5D is a cross-sectional view of constituent element for all of FIGS. 5A to 5C. The optical component according to the present embodiment also includes the same spacer as illustrated in FIGS. 1A and 1B, however, the description is omitted in FIGS. 4A to 5D. An optical component 31 is being used in an optical system of camera module which is mounted in an electronic apparatus such as a portable phone and a smartphone.

As illustrated in FIGS. 4A and 4B, in the optical component 31, a first lens group G11 and a second lens group G12 which are made of a transparent resin are respectively formed on two glass substrates 32 and 33. The first lens group G11 is configured to be a lens L11 that is formed on a substrate surface (substrate surface of an upper side in the drawing) of a subject side of the glass substrate 32 and a lens L12 that is formed on a substrate surface (substrate surface of a lower side in the drawing) of an image side of the glass substrate 32. The second lens group G12 is configured to be a lens L13 that is formed on a substrate surface of subject side of the glass substrate 33 and a lens L14 that is formed on a substrate surface of image side of the glass substrate 33.

As illustrated in FIG. 5B, for example, the lens L13 includes a protrusion portion L13a on the surface of the subject side along the four sides of a rectangle. As illustrated in FIG. 5A, the lens L12 also includes a protrusion portion L12a on the surface of the subject side along the four sides of a rectangular substrate, however, on at least one side only (right side in FIG. 5A), the protrusion portion L12a is located deeper inside than the other sides away from the side (end portion).

As illustrated in FIGS. 4A and 4B, the protrusion portion L12a of lens L12 and the protrusion portion L13a of lens L13 are opposed to each other, and are bonded to an adhesive (ultraviolet curable resin) 36 through a fluorine resin porous film 35. The fluorine resin porous film 35, as illustrated in FIG. 5C, is a thin sheet in the shape of square frame, and as illustrated in FIGS. 5C and 5D, on the side to the inside of which the aforementioned protrusion portion L12a is located, the frame width of the protrusion portion L12a becomes wider so as to match the position of the protrusion portion L12a. Accordingly, on the side to the inside of which the protrusion portion L12a is located, as illustrated in FIGS. 4A and 4B, the fluorine resin porous film 35 is interposed by being coupled to both the protrusion portion L12a and the protrusion portion L13a. In this way, the glass substrates 32 and 33 are bonded through the fluorine resin porous film 35 in such a manner that a hollow portion 34 which is an enclosed space is formed between the glass substrate 32 and the glass substrate 33. As the fluorine resin porous film 35, for example, “TEMISH” (registered trademark) manufactured by Nitto Denko Corp. is used.

The fluorine resin porous film 35 is an example where a porous material is used as a film, and has the characteristic of high breathability. Since the fluorine resin porous film 35 has such a characteristic, in the optical component 31, air and water vapor in the hollow portion 34 (molecular diameter of approximately 0.0004 μm) are discharged to the outside through the fluorine resin porous film 35 (in particular, the portion which is connected to both the protrusion portion L12a which is located to the above-mentioned inside and the protrusion portion L13a).

According to such a structure of the optical component 31 having such a structure, when soldering using reflow is performed, air inside the hollow portion 34 which expands due to heat is discharged to the outside through the fluorine resin porous film 35. In this way, it may be possible to prevent cracking from occurring in the adhesive portion (fluorine resin porous film 35 and adhesive 36) due to the expansion of the air inside the hollow portion 4, without causing the structure to be enlarged or complicated.

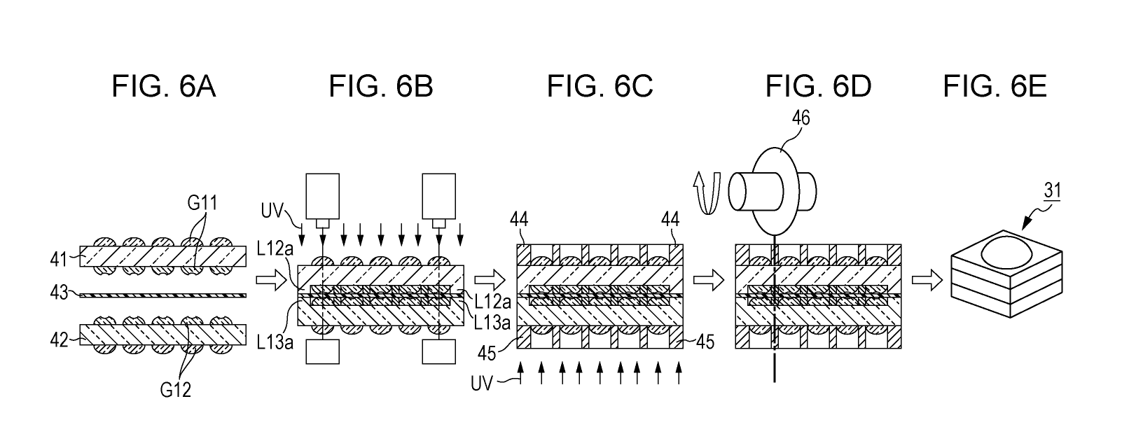

FIG. 6A to 6E illustrate a method of manufacturing the optical component 31 as illustrated in FIGS. 4A and 4B, and the same reference numerals to portions common to FIGS. 4A to 5D.

As illustrated in FIG. 6A, the plurality of first lens groups G11 and second lens groups G12 are respectively formed on glass substrates 41 and 42. Further, the fluorine resin porous film 35, as illustrated in FIG. 5C, is formed in a shape so as to be coupled and arranged in plural number, that is, a fluorine resin porous film 43 which is provided with plural holes 35a at positions corresponding to the individual optical components of the fluorine resin porous film is formed.

Subsequently, as illustrated in FIG. 6B, the glass substrate 41 and the glass substrate 42 are opposed and aligned to each other with the fluorine resin porous film 43 interposed therebetween. Further, an ultraviolet curable resin (not illustrated but the adhesive 36 in FIGS. 4A and 4B) is applied to each protrusion portion of the first lens group G11 and the second lens group G12 (protrusion portions L12a and L13a of FIGS. 4A to 5D). In addition, ultraviolet rays UV are uniformly irradiated and the ultraviolet curable resin is cured, thus the glass substrate 41 and the glass substrate 42 are bonded through the fluorine resin porous film 43.

Further, for the convenience of description, in FIGS. 6B to 6D, only the protrusion portions L12a and L13a which are formed in the vicinity of the outer periphery portion of the glass substrates 41 and 42 are illustrated as being thick, while the rest of protrusion portions L12a and L13a which are disposed outside thereof are illustrated as being thin.

Subsequently, as illustrated in FIG. 6C, on a substrate surface of the subject side of the glass substrate 41, the ultraviolet curable resin (not illustrated) is applied to the peripheral region of each of the first lens groups G11, a spacer 44 for lens protection is placed thereon, and the ultraviolet rays UV are irradiated uniformly, such that the spacer 44 is bonded. In the same manner, in the substrate surface of an image side of the glass substrate 42, a spacer 45 is bonded to a peripheral region of each of the second lens groups G12.

Subsequently, the glass substrates 41 and 42 which are bonded in this way, as illustrated in FIG. 6D, are divided into respective components by dividing the fluorine resin porous film 43 in the peripheral region of each of the first lens groups G11 and the second lens groups G12 using a dicer 46 as a dividing line. In this way, the optical component 31 (the same structure as illustrated in FIGS. 4A and 4B) the appearance of which is schematically shown in FIG. 6E is manufactured in plural number simultaneously. Further, in FIG. 6E, the spacers 44 and 45 illustrated in FIGS. 6C and 6D are omitted.

### 4. Modified Example

### Modified Example 1

In the first embodiment, the glass substrates 2 and 3 are bonded through the silicone RTV resin 5. However, as a modified example, the glass substrates 2 and 3 may be bonded to each other through a material using a silicone RTV resin in one portion. Even in such a case, when soldering is performed using reflow, air in the hollow portion 4 which expands due to the heat is discharged to the outside through a portion of silicone RTV resin out of a material which separates the hollow portion 4 from the outside. Accordingly, further, it may be possible to prevent cracking in the adhesive layer caused by expansion of the air in the hollow portion 4 from occurring without causing the structure to be enlarged or complicated.

In the same manner, also in the third embodiment, as a modified example, the two glass substrates 32 and 33 may be bonded to each other through a material using a fluorine resin porous film in one portion.

### Modified Example 2

In the first embodiment mentioned above, a lens is formed on each of the glass substrates 2 and 3. However, as a modified example, a lens is formed on only one glass substrate out of the glass substrates 2 and 3.

In the same manner, also in the third embodiment, as a modified example, a lens is formed on only one of the two glass substrates 32 and 33.

### Modified Example 3

In the second embodiment, one optical component 1 according to the first embodiment is used. However, as a modified example, the optical component 1 according to the first embodiment (various shapes depending on a role, or the like as for a shape of lens) may be used by a plurality being stacked up. Further, an optical component 31 according to a third embodiment may be used by either one or a plurality being stacked up. Further, the optical component 1 according to the first embodiment and the optical component 31 according to the third embodiment may be combined and used by a plurality being stacked up.

### Modified Example 4

In the third embodiment, the glass substrate 32 and the glass substrate 33 are bonded to each other through the thin sheet type-fluorine resin porous film 35. However, as a modified example, the glass substrate 32 and the glass substrate 33 are bonded to each other through a thick block type-fluorine resin porous material.

### Modified Example 5

In the first and third embodiments, as a porous material, a silicone RTV resin and a fluorine resin porous film are used. However, as a modified example, porous materials other than the silicone RTV resin and the fluorine resin porous film may be used. Further, at least one out of the silicone RTV resin and the fluorine resin porous film may be included, and a porous material which includes the other material thereof may be used.

Further, the present disclosure is not limited to the embodiment described above, but includes various applied and modified examples thereof without departing from the scope described in the patent claims of the present disclosure.

In addition, the present disclosure may take following configuration.

(1) An optical component includes a first glass substrate, a second glass substrate that opposes the first glass substrate, a lens that is formed on at least one of the first glass substrate and the second glass substrate, and a connection portion that is interposed between the two glass substrates in such a manner that a hollow portion is formed between the first glass substrate and the second glass substrate, and is configured to use a material which includes a porous material in at least one portion.

(2) The optical component according to (1), wherein the porous material includes a silicone resin, and wherein the first glass substrate and the second glass substrate are bonded to each other through the connection portion.

(3) The optical component according to (1) or (2), wherein the porous material includes a fluorine resin porous film, and wherein the first glass substrate and the second glass substrate are bonded to each other through the connection portion.

(4) A method of manufacturing an optical component includes applying a silicone resin to a peripheral region of a lens for each glass substrate where a plurality of lenses are arranged and formed, and bonding two glass substrates of the glass substrate and a different glass substrate through the silicone resin in such a manner that the two glass substrates oppose each other and have a hollow portion therebetween for each lens region, and dividing the two bonded glass substrates into respective components using the silicone applied to the peripheral region of each lens as a dividing line.

(5) A camera module includes an imaging device, and an optical system causing an image of subject to be incident on an imaging device, and wherein the optical system includes a first glass substrate, a second glass substrate that opposes the first glass substrate, a lens that is formed on at least one of the first glass substrate and the second glass substrate, and a connection portion that is interposed between the two glass substrates in such a manner that a hollow portion is formed between the first glass substrate and the second glass substrate, and is configured to use a material which includes a porous material in at least one portion.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An optical component comprising:
a first glass substrate;
a second glass substrate that opposes the first glass substrate;
a lens that is formed on at least one of the first glass substrate and the second glass substrate; and
a connection portion that is interposed between the two glass substrates in such a manner that a hollow portion is formed between the first glass substrate and the second glass substrate, and is configured to use a material which includes a porous material in at least one portion.

2. The optical component according to the claim 1,
wherein the porous material includes a silicone resin, and
wherein the first glass substrate and the second glass substrate are bonded to each other through the connection portion.

3. The optical component according to the claim 1,
wherein the porous material includes a fluorine resin porous film, and
wherein the first glass substrate and the second glass substrate are bonded to each other through the connection portion.

4. A method of manufacturing an optical component comprising:
applying a silicone resin to a peripheral region of a lens for each glass substrate where a plurality of lenses are arranged and formed, and bonding two glass substrates of the glass substrate and a different glass substrate through the silicone resin in such a manner that the two glass substrates oppose each other and have a hollow portion therebetween for each lens region, and
dividing the two bonded glass substrates into respective components using the silicone applied to the peripheral region of each lens as a dividing line.

5. A camera module comprising:
an imaging device; and
an optical system causing an image of subject to be incident on the imaging device; and
wherein the optical system includes
a first glass substrate,
a second glass substrate that opposes the first glass substrate,
a lens that is formed on at least one of the first glass substrate and the second glass substrate, and
a connection portion that is interposed between the two glass substrates in such a manner that a hollow portion is formed between the first glass substrate and the second glass substrate, and is configured to use a material which includes a porous material in at least one portion.
